(19) United States
(12) Patent Application Publication
(10) Pub. No.: US 2023/0334807 A1
(43) Pub. Date: Oct. 19, 2023

(54) INFORMATION PROCESSING DEVICE, INFORMATION PROCESSING METHOD, AND PROGRAM

(71) Applicant: NEC Corporation, Tokyo (JP)

(72) Inventors: Kiri Inayoshi, Tokyo (JP); Takashi Nonaka, Tokyo (JP); Kentaro Nishida, Tokyo (JP)

(73) Assignee: NEC Corporation, Tokyo (JP)

(21) Appl. No.: 18/132,071

(22) Filed: Apr. 7, 2023

(30) Foreign Application Priority Data
Apr. 13, 2022 (JP) 2022-066439

(51) Int. Cl. G06T 19/20; G06V 20/64; G06T 15/04; G06V 10/778

(52) U.S. Cl. CPC G06T 19/20; G06V 20/653; G06T 15/04; G06V 10/7788; G06T 2219/2021; G06T 2219/2016; G06T 2200/24; G06T 2210/04

(57) ABSTRACT

An information processing device includes at least one processor configured to execute: an obtaining process of obtaining three-dimensionally scanned data; an identifying process of identifying a three-dimensional model corresponding to the subject; and an output process of outputting the three-dimensional model, the at least one processor being further configured to execute, in the identifying process, an object detecting process of performing a process of object detection to identify an object; and a searching process of searching, in three-dimensional model candidates, for the three-dimensional model corresponding to the object.

### CROSS REFERENCE TO RELATED APPLICATIONS

This application is based upon and claims the benefit of priority from Japanese Patent Application No. 2022-066439 filed on Apr. 13, 2022, the disclosure of which is incorporated herein in its entirety by reference.

### TECHNICAL FIELD

The present invention relates to an information processing device, an information processing method, and a program.

### BACKGROUND ART

There has been disclosed a technique related to a three-dimensional modeling that generates three-dimensional model data on the basis of three-dimensionally scanned data obtained by scanning a subject.

The technique disclosed in Patent Literature 1 performs three-dimensional reconstruction on the basis of a captured image of an inspection subject so as to generate reconstruction data, and matches the reconstruction data against a standard model, which is a standard three-dimensional model of the inspection subject. Then, the technique disclosed in Patent Literature 1 displays an image of the standard model and the reconstruction data projected in two-dimensional coordinates.

### CITATION LIST

### Patent Literature

[Patent Literature 1]
International Publication No. WO 2021/234907

### SUMMARY OF INVENTION

### Technical Problem

However, the technique disclosed in Patent Literature 1 can be used only when the inspection subject is determined, disadvantageously. Further, the technique disclosed in Patent Literature 1 is disadvantageous also in that this technique, which displays the image projected in two-dimensional coordinates, cannot provide a user with a three-dimensional model of the inspection subject.

An example aspect of the present invention was made in view of the above problems, and has an example object to provide a technique that provides a three-dimensional model of a subject in a suitable manner.

### Solution to Problem

An information processing device in accordance with an example aspect of the present invention includes at least one processor configured to execute: an obtaining process of obtaining three-dimensionally scanned data obtained by sensing one or more objects; an identifying process of referring to the three-dimensionally scanned data and identifying a three-dimensional model corresponding to at least any one of the one or more objects; and an output process of outputting the three-dimensional model thus identified, the at least one processor being further configured to execute, in the identifying process, an object detecting process and a searching process, the object detecting process performing a process of object detection on the three-dimensionally scanned data, so as to identify the at least any one of the one or more objects, and the searching process searching, in a plurality of three-dimensional model candidates, for the three-dimensional model corresponding to the at least any one of the one or more objects.

An information processing method in accordance with an example aspect of the present invention includes: at least one processor obtaining three-dimensionally scanned data obtained by sensing one or more objects; the at least one processor referring to the three-dimensionally scanned data and identifying a three-dimensional model corresponding to at least any one of the one or more objects; and the at least one processor outputting the three-dimensional model thus identified, the identifying including: performing a process of object detection on the three-dimensionally scanned data, so as to identify the at least any one of the one or more objects, and searching, in a plurality of three-dimensional model candidates, for the three-dimensional model corresponding to the at least any one of the one or more objects.

A computer-readable non-transitory storage medium in which a program in accordance with an example aspect of the present invention is stored, the program causing a computer to function as an information processing device, the program causing the computer to execute: an obtaining process of obtaining three-dimensionally scanned data obtained by sensing one or more objects; an identifying process of referring to the three-dimensionally scanned data and identifying a three-dimensional model corresponding to at least any one of the one or more objects; an output process of outputting the three-dimensional model thus identified, the program causing the computer to further execute, in the identifying process, an object detecting process and a searching process: the object detecting process performing a process of object detection on the three-dimensionally scanned data, so as to identify the at least any one of the one or more objects; and the searching process searching, in a plurality of three-dimensional model candidates, for the three-dimensional model corresponding to the at least any one of the one or more objects.

### Advantageous Effects of Invention

According to an example aspect of the present invention, it is possible to provide a three-dimensional model of a subject in a suitable manner.

### BRIEF DESCRIPTION OF DRAWINGS

FIG. 1 is a block diagram illustrating a configuration of an information processing device in accordance with a first example embodiment of the present invention.

FIG. 2 is a flowchart illustrating a flow of an information processing method in accordance with the first example embodiment of the present invention.

FIG. 3 is a flowchart illustrating a flow of step S12 to be performed by an identifying section in accordance with the first example embodiment of the present invention.

FIG. 4 is a block diagram illustrating a configuration of an information processing system in accordance with a second example embodiment of the present invention.

FIG. 5 is a view illustrating an example of an outline of a process to be executed by an information processing system in accordance with the second example embodiment of the present invention.

FIG. 6 is a view illustrating an example of an image to be presented to a user in the second example embodiment of the present invention.

FIG. 7 is a block diagram illustrating a configuration of an information processing system in accordance with a third example embodiment of the present invention.

FIG. 8 is a view illustrating an example of an image to be presented to a user in the third example embodiment of the present invention.

FIG. 9 is a block diagram illustrating a configuration of an information processing system in accordance with a fourth example embodiment of the present invention.

FIG. 10 is a block diagram illustrating an example of a hardware configuration of an information processing device and a terminal device in accordance with each example embodiment of the present invention.

### EXAMPLE EMBODIMENTS

### First Example Embodiment

The following description will discuss a first example embodiment of the present invention in detail with reference to the drawings. The present example embodiment is a basic form of example embodiments described later.

(Outline of Information Processing Device 1)

An information processing device 1 in accordance with the present example embodiment is a device that outputs, on the basis of three-dimensionally scanned data obtained by sensing one or more subjects, a three-dimensional model corresponding to at least any one of the one or more subjects.

There is no particular limitation on the “one or more subjects”. Examples of the subject include furniture, an electric appliance, and kitchenware.

The “three-dimensionally scanned data” is data obtained by sensing the one or more subjects. In other words, the “three-dimensionally scanned data” includes the one or more subjects. Examples of the “three-dimensionally scanned data” include point group data including points having three-dimensional coordinates (x, y, z). The sensing of the subject(s) also include capturing an image of the subject(s).

An example of a method for obtaining the three-dimensionally scanned data can be a method involving use of Light Detection And Ranging (LiDAR) that measures a distance to the subject(s). Another example of the method for obtaining the three-dimensionally scanned data can be a method involving use of parallax between image-capturing devices each of which captures an image of the subject(s).

(Configuration of Information Processing Device 1)

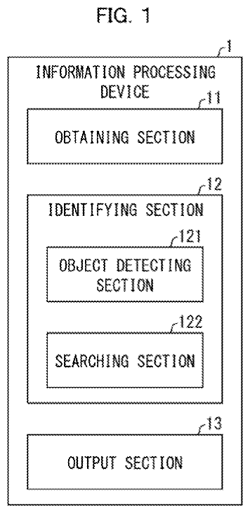

The following will describe, with reference to FIG. 1, a configuration of an information processing device 1 in accordance with the present example embodiment. FIG. 1 is a block diagram illustrating a configuration of the information processing device 1 in accordance with the present example embodiment.

As shown in FIG. 1, the information processing device 1 in accordance with the present example embodiment includes an obtaining section 11, an identifying section 12, and an output section 13. The obtaining section 11, the identifying section 12, and the output section 13 respectively realize an obtaining means, an identifying means, and an output means in the present example embodiment.

The obtaining section 11 obtains three-dimensionally scanned data obtained by sensing one or more subjects. The obtaining section 11 supplies, to the identifying section 12, the three-dimensionally scanned data thus obtained.

The identifying section 12 refers to the three-dimensionally scanned data supplied from the obtaining section 11, and identifies a three-dimensional model corresponding to at least any one of the one or more subjects. The identifying section 12 supplies, to the output section 13, information indicating the three-dimensional model thus identified.

As shown in FIG. 1, the identifying section 12 includes an object detecting section 121 and a searching section 122. The object detecting section 121 and the searching section 122 respectively realize an object detecting means and a searching means in the present example embodiment.

The object detecting section 121 refers to the three-dimensionally scanned data supplied from the obtaining section 11 and performs a process of object detection on the three-dimensionally scanned data, thereby identifying at least any one of the one or more objects. The object detecting section 121 supplies, to the searching section 122, information indicating at least any one of the one or more objects thus identified.

The searching section 122 searches, in a plurality of three-dimensional model candidates, for a three-dimensional model corresponding to at least any one of one or more objects indicated by the information supplied from the object detecting section 121. The searching section 122 supplies, to the output section 13, the three-dimensional model identified as a result of the searching.

The output section 13 outputs the three-dimensional model identified by the identifying section 12.

As discussed above, the information processing device 1 in accordance with the present example embodiment employs a configuration including: the obtaining section 11 that obtains three-dimensionally scanned data obtained by sensing one or more subjects; the identifying section 12 that refers to the three-dimensionally scanned data and identifies a three-dimensional model corresponding to at least any one of the one or more subjects; and the output section 13 that outputs the three-dimensional model thus identified.

In the information processing device 1 in accordance with the present example embodiment, the identifying section 12 includes: the object detecting section 121 that performs the process of object detection on the three-dimensionally scanned data, so as to identify the at least any one of the one or more objects; and the searching section 122 that searches, in a plurality of three-dimensional model candidates, for the three-dimensional model corresponding to the at least any one of the one or more objects.

Thus, with the information processing device 1 in accordance with the present example embodiment, which detects an object included in three-dimensionally scanned data and outputs a three-dimensional model corresponding to the subject thus detected, it is possible to attain the effect of suitably providing the three-dimensional model of the subject.

(Flow of Information Processing Method S1)

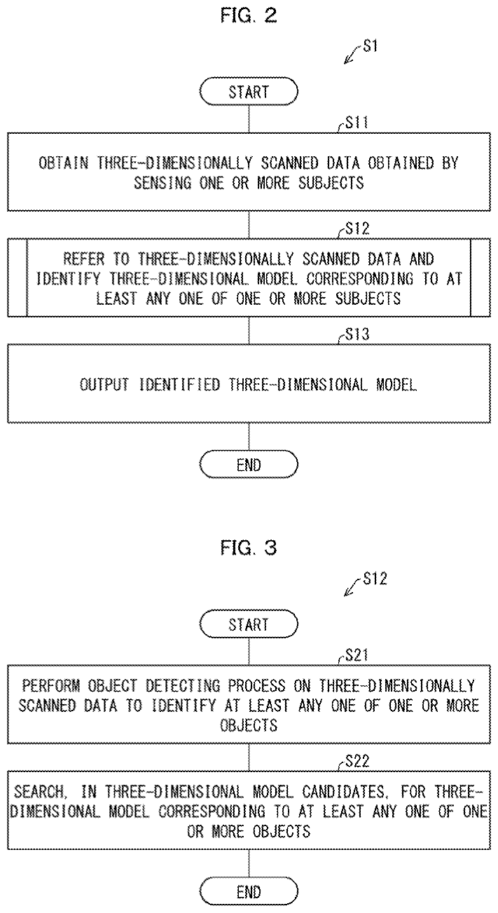

The following will describe, with reference to FIG. 2, a flow of an information processing method S1 in accordance with the present example embodiment. FIG. 2 is a flowchart illustrating a flow of the information processing method S1 in accordance with the present example embodiment.

(Step S11)

In step S11, the obtaining section 11 obtains three-dimensionally scanned data obtained by sensing one or more subjects. The obtaining section 11 supplies, to the identifying section 12, the three-dimensionally scanned data thus obtained.

(Step S12)

In step S12, the identifying section 12 refers to the three-dimensionally scanned data supplied from the obtaining section 11 in step S11, and identifies the three-dimensional model corresponding to the at least any one of the one or more subjects. A more specific flow of step S12 performed by the identifying section 12 will be described later. The identifying section 12 supplies, to the output section 13, information indicating the three-dimensional model thus identified.

(Step S13)

In step S13, the output section 13 outputs the three-dimensional model identified by the identifying section 12 in step S12.

(Flow of step S12)

The following will describe, with reference to FIG. 3, a more specific flow of step S12 to be performed by the identifying section 12 in accordance with the present example embodiment. FIG. 3 is a flowchart illustrating a flow of step S12 to be performed by the identifying section 12 in accordance with the present example embodiment.

(Step S21)

In step S21, the object detecting section 121 refers to the three-dimensionally scanned data supplied from the obtaining section 11 and performs the process of object detection on the three-dimensionally scanned data, thereby identifying the at least any one of the one or more objects. The object detecting section 121 supplies, to the searching section 122, information indicating the at least any one of the one or more objects thus identified.

(Step S22)

In step S22, the searching section 122 searches, in a plurality of three-dimensional model candidates, for the three-dimensional model corresponding to at least any one of the one or more objects indicated by the information supplied from the object detecting section 121. The searching section 122 supplies, to the output section 13, the three-dimensional model identified as a result of the searching.

As discussed above, in the information processing method S1 in accordance with the present example embodiment, in step S11, the obtaining section 11 obtains three-dimensionally scanned data obtained by sensing one or more subjects; in step S12, the identifying section 12 refers to the three-dimensionally scanned data and identifies a three-dimensional model corresponding to at least any one of the one or more subjects; and in step S13, the output section 13 outputs the three-dimensional model thus identified.

In the identifying processing step S12 in accordance with the present example embodiment, in step S21, the object detecting section 121 performs a process of object detection on three-dimensionally scanned data, so as to identify at least any one of the one or more objects; and in step S22, the searching section 122 searches, in a plurality of three-dimensional model candidates, for a three-dimensional model corresponding to at least any one of the one or more objects.

Thus, with the information processing method S1 in accordance with the present example embodiment, it is possible to attain similar effects to those given by the above-described information processing device 1.

### Second Example Embodiment

The following description will discuss a second example embodiment of the present invention in detail with reference to the drawings. Note that members having identical functions to those of the first example embodiment are given identical reference signs, and a description thereof will be omitted.

(Configuration of Information Processing System 100A)

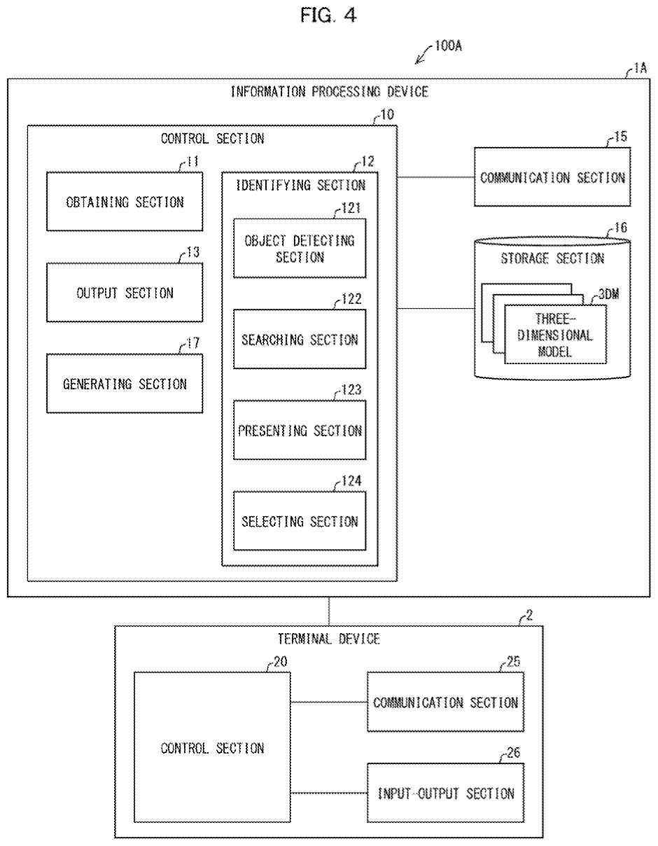

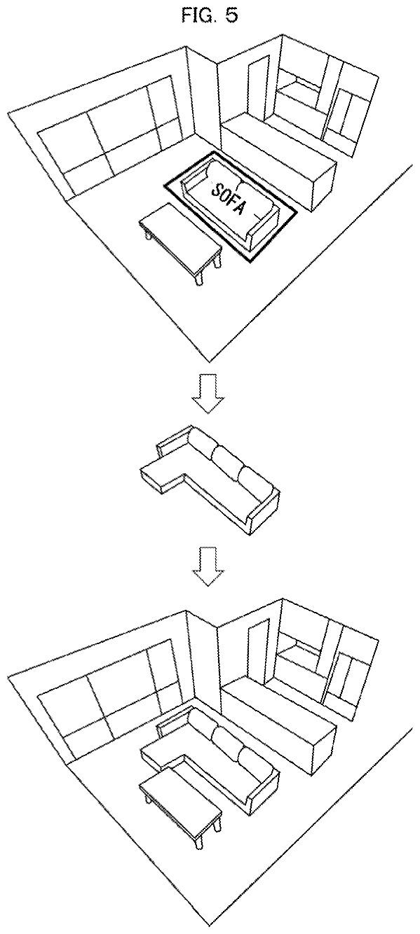

The following will describe, with reference to FIG. 4, an information processing system 100A in accordance with the present example embodiment. FIG. 4 is a block diagram illustrating a configuration of the information processing system 100A in accordance with the present example embodiment.

As shown in FIG. 4, the information processing system 100A in accordance with the present example embodiment includes an information processing device 1A and a terminal device 2.

The information processing device 1A and the terminal device 2 are communicably connected to each other. The information processing device 1A and the terminal device 2 may be communicably connected to each other via a network (not illustrated). In this case, an example of a specific configuration of the network may be wireless Local Area Network (LAN), wired LAN, Wide Area Network (WAN), a public network, a mobile data communication network, or a combination of these. However, the present example embodiment is not limited to this.

In the information processing system 100A, the information processing device 1A refers to three-dimensionally scanned data obtained by the terminal device 2, and identifies a three-dimensional model corresponding to at least any one of one or more subjects included in the three-dimensionally scanned data. Then, the information processing device 1A outputs, to the terminal device 2, the three-dimensional model thus identified. The terminal device 2 obtains the three-dimensional model output from the information processing device 1A.

The three-dimensionally scanned data of the one or more subjects is as discussed earlier.

(One Example of Outline of Process to be Executed by Information Processing System 100A)

The following will describe, with reference to FIG. 5, an example of an outline of a process to be executed by the information processing device 100A. FIG. 5 is a view illustrating an example of an outline of a process to be executed by the information processing system 100A in accordance with the present example embodiment.

First, the terminal device 2 obtains three-dimensionally scanned data. In an example, the terminal device 2 obtains the three-dimensionally scanned data such as the one shown in the upper image of FIG. 5. The terminal device 2 outputs, to the information processing device 1A, the three-dimensionally scanned data thus obtained.

Upon obtaining of the three-dimensionally scanned data output from the terminal device 2, the information processing device 1A identifies at least any one of the one or more subjects included in the three-dimensionally scanned data. In an example, the information processing device 1A identifies the subject “sofa”, which is included in the three-dimensionally scanned data, as shown in the upper image of FIG. 5.

Next, the information processing device 1A outputs, to the terminal device 2, a three-dimensional model corresponding to the subject thus identified. In an example, as shown in the center image in FIG. 5, the information processing device 1A outputs, to the terminal device 2, the three-dimensional model corresponding to the subject “sofa”, which is included in the three-dimensionally scanned data having been identified.

Alternatively, the information processing device 1A may output, to the terminal device 2, three-dimensional data corresponding to at least part of the three-dimensionally scanned data. Examples of the “three-dimensional data corresponding to at least part of the three-dimensionally scanned data” include three-dimensional data which is included in the three-dimensionally scanned data and which corresponds to data other than the data corresponding to the three-dimensional model. In an example, the information processing device 1A may output, to the terminal device 2, all of or part (e.g., a wall, a desk) of the data other than the data corresponding to the “sofa” in the three-dimensionally scanned data.

Next, the terminal device 2 obtains the three-dimensional model output from the information processing device 1A. In an example, the terminal device 2 presents the three-dimensional model having been obtained. In an example, as shown in the lower image in FIG. 5, the terminal device 2 presents an image in which the subject “sofa” is replaced with the three-dimensional model having been obtained and which is a stereoscopically visible image obtained by referring to the three-dimensionally scanned data indicated in the upper portion of FIG. 5 (or three-dimensional data corresponding to at least part of the three-dimensionally scanned data output from the information processing device 1A). Use of the image enables the information processing system 100A to present, to a user, a back side of the sofa in a stereoscopically visible manner, although the three-dimensionally scanned data cannot present the back side of the sofa to the user.

(Configuration of Terminal Device 2)

As shown in FIG. 4, the terminal device 2 includes a control section 20, a communication section 25, and an input-output section 26.

The control section 20 controls constituent elements included in the terminal device 2. In an example, the control section 20 supplies, to the communication section 25, data obtained from the input-output section 26, and supplies, to the input-output section 26, data obtained from the communication section 25.

The communication section 25 is a communication module that communicates with another device connected thereto. In an example, the communication section 25 outputs, to the information processing device 1A, data supplied from the communication section 20, and supplies, to the control section 20, data output from the information processing device 1A.

The input-output section 26 is a device that receives an input of data. The input-output section 26 is also a device that outputs data. In an example, the input-output section 26 supplies, to the control section 20, data input thereto, and outputs data supplied from the control section 20. Examples of the data to be received by the input-output section 26 include three-dimensionally scanned data and information indicating an input from a user. Examples of the data to be output by the input-output section 26 include a three-dimensional model, a three-dimensional model candidate, and a stereoscopically visible image.

(Configuration of Information Processing Device 1A)

As shown in FIG. 4, the information processing device 1A includes a control section 10, a communication section 15, and a storage section 16.

The communication section 15 is a communication module that communicates with another device connected thereto. In an example, the communication section 15 outputs, to the terminal device 2, data supplied from the control section 10, and supplies, to the control section 20, data output from the terminal device 2.

In the storage section 16, data to be referred to by the control section 10 is stored. Examples the data stored in the storage section 16 include a plurality of three-dimensional models 3DM.

(Function of Control Section 10)

The control section 10 controls constituent elements included in the information processing device 1A. As shown in FIG. 4, the control section 10 functions also as an obtaining section 11, an identifying section 12, an output section 13, and a generating section 17. The obtaining section 11, the identifying section 12, the output section 13, and the generating section 17 respectively realize an obtaining means, an identifying means, an output means, and a generating means in the present example embodiment.

The obtaining section 11 obtains data supplied from the communication section 15. Examples of the data to be obtained by the obtaining section 11 include three-dimensionally scanned data and information indicating an input from a user. The obtaining section 11 supplies the obtained data to the identifying section 12, the output section 13, and the generating section 17.

The identifying section 12 refers to the three-dimensionally scanned data, and identifies a three-dimensional model corresponding to at least any one of the one or more subjects. In an example, the identifying section 12 refers to the three-dimensionally scanned data supplied from the obtaining section 11, and identifies a three-dimensional model corresponding to at least any one of the one or more subjects, from among a plurality of three-dimensional models 3DM stored in the storage section 16.

As shown in FIG. 4, the identifying section 12 may include an object detecting section 121, a searching section 122, a presenting section 123, and a selecting section 124. The object detecting section 121, the searching section 122, the presenting section 123, and the selecting section 124 respectively realize an object detecting means, a searching means, a presenting means, and a selecting means in the present example embodiment.

The object detecting section 121 refers to the three-dimensionally scanned data supplied from the obtaining section 11 and performs the process of object detection on the three-dimensionally scanned data, thereby identifying at least one of the one or more objects. The object detecting section 121 supplies, to the searching section 122, information indicating at least any one of the one or more objects thus identified. An example of the process in which the object detecting section 121 detects an object will be described later.

The searching section 122 searches, in a plurality of three-dimensional model candidates, a three-dimensional model corresponding to at least any one of the one or more objects indicated by the information supplied from the object detecting section 121.

The searching section 122 may perform the searching with use of similarities between the three-dimensional model and the three-dimensional model candidates.

The searching section 122 may accept, from a user, information designating a partial space in a subject space including the one or more subjects, and may apply the process of object detection to three-dimensionally scanned data corresponding to the partial space identified on the basis of the information designating the partial space.

An example of the process to be executed by the searching section 122 will be described later.

The presenting section 123 presents, to a user, a plurality of three-dimensional model candidates having a relatively high similarity, among the plurality of three-dimensional model candidates with respect to which the searching section 122 has performed the searching. An example of the process to be executed by the presenting section 123 will be described later.

The selecting section 124 selects, on the basis of an input from the user performed with respect to the three-dimensional model candidates presented by the presenting section 123, a three-dimensional model corresponding to at least any one of the one or more subjects. An example of the process to be executed by the selecting section 124 will be described later.

The output section 13 outputs the three-dimensional model identified by the identifying section 12. The output section 13 may output, as the three-dimensional model having been identified, information indicating the three-dimensional model itself (e.g., an image of the three-dimensional model, an identifier of the three-dimensional model). The output section 13 may output an image including the three-dimensional model (e.g., an image generated by the later-described generating section 17).

As discussed above, the output section 13 may output, in addition to the three-dimensional model identified by the identifying section 12, three-dimensional data corresponding to at least part of the three-dimensionally scanned data. With this configuration, the output section 13 can provide, in a separated manner, (a) three-dimensional data of the subject included in the three-dimensionally scanned data and (b) three-dimensional data of those other than the subject.

The generating section 17 generates a stereoscopically visible image which can be obtained by referring to the three-dimensionally scanned data and in which at least any one of the one or more subjects is replaced with a three-dimensional model. The generating section 17 supplies the generated image to the output section 13. An example of the process to be executed by the generating section 17 will be described later.

Note here that the “stereoscopically visible image” refers to an image which is generated on the basis of three-dimensional data and which is configured to enable a user who sees the image to recognize that the image represents a three-dimensional object.

In an example, the “stereoscopically visible image” can be viewed from different viewpoints, and provides a stereoscopic impression to a user.

In a case of employing a display device, e.g., a virtual reality (VR) goggle, that can separately provide a right-eye image and a left-eye image, the “stereoscopically visible image” may be composed of the right-eye image and the left-eye image that have parallax therebetween so as to provide the user with a stereoscopic effect by the parallax.

The process to be executed by the generating section 17 may be executed by the control section 20 of the terminal device 2. In other words, the control section 20 of the terminal device 2 may function as the generating section 17. In this case, the control section 20 of the terminal device 2 refers to the three-dimensional model output from the information processing device 1A, and generates a stereoscopically visible image which can be obtained by referring to the three-dimensionally scanned data and in which at least any one of the one or more subjects is replaced with a three-dimensional model.

(One Example of Object Detection Process to be Executed by Object Detecting Section 121)

The following will describe an example of the process in which the object detecting section 121 detects an object.

In an example, the object detecting section 121 is configured to use a detection model that accepts, as an input, three-dimensionally scanned data and outputs one or more objects included in the three-dimensionally scanned data. In this configuration, the object detecting section 121 inputs, to the detection model, the three-dimensionally scanned data supplied from the obtaining section 11, and identifies that one or more objects output therefrom are at least any one of the one or more objects included in the three-dimensionally scanned data.

A specific configuration of the detection model is not limited, and may be, for example, Convolution Neural Network (CNN), Recurrent Neural Network (RNN), or a combination thereof. For another example, a non-neural network model such as Random Forest and Support Vector Machine may be employed.

For example, the object detecting section 121 inputs, to the detection model, the three-dimensionally scanned data indicated in the upper part of FIG. 5. In a case where the detection model outputs a “sofa”, a “table”, a “chair”, and a “refrigerator”, the object detecting section 121 determines that the subjects included in the three-dimensionally scanned data are the “sofa”, “table”, “chair”, and “refrigerator”.

As discussed above, the object detecting section 121 performs the process of object detection on three-dimensionally scanned data, so as to identify at least any one of one or more objects. This makes it possible to appropriately detect one or more objects included in the three-dimensionally scanned data.

(Another Example of Process to be Executed by Object Detecting Section 121)

The following will describe another example of a process to be executed by the object detecting section 121.

In an example, the object detecting section 121 may be configured to apply the process of object detection on three-dimensionally scanned data corresponding to a partial space which is designated by a user and which is in a subject space including one or more subjects.

For example, the object detecting section 121 accepts, from the user, information designating a partial space in a subject space which is three-dimensionally scanned data. In an example, the object detecting section 121 obtains, from the terminal device 2, information which indicates an input from the user and which designates the partial space. Then, the object detecting section 121 applies the process of object detection on the three-dimensionally scanned data corresponding to the partial space identified on the basis of the obtained information.

In this manner, the object detecting section 121 executes, on the basis of the information from the user, the process of object detection on the three-dimensionally scanned data corresponding to the partial space. This makes it possible to appropriately detect one or more objects included in the three-dimensionally scanned data.

(One Example of Process to be Executed by Searching Section 122)

The following will describe an example of a process to be executed by the searching section 122.

In an example, the searching section 122 searches, in a plurality of three-dimensional models 3DM stored in the storage section 16, a three-dimensional model corresponding to at least any one of the one or more objects identified by the object detecting section 121. The searching section 122 supplies, to the output section 13, the generating section 17, and the presenting section 123, the three-dimensional model identified as a result of the searching.

For example, in a case where the three-dimensional models 3DM stored in the storage section 16 are associated with names of objects, the searching section 122 searches for a three-dimensional model(s) 3DM which is/are associated with a name(s) of the one or more objects identified by the object detecting section 121 and which is/are stored in the storage section 16. In an example, in a case where a “sofa” is identified by the object detecting section 121, the searching section 122 searches, in the three-dimensional models 3DM stored in the storage section 16, for a three-dimensional model 3DM associated with the name “sofa”, which is the name of the object.

As discussed above, the searching section 122 searches, in a plurality of three-dimensional model candidates, for a three-dimensional model corresponding to at least any one of one or more objects. This makes it possible to identify an appropriate three-dimensional model.

(Another Example of Process to be Executed by Searching Section 122)

The following will describe another example of a process to be executed by the searching section 122.

In an example, the searching section 122 is configured to use a similarity determination model that accepts, as an input, a three-dimensional model and a three-dimensional model candidate and determines a similarity between the three-dimensional model and the three-dimensional model candidate.

For example, the searching section 122 generates a three-dimensional model of, among the objects included in the three-dimensionally scanned data, an object detected by the object detecting section 121. Then, the searching section 122 inputs, to the similarity determination model, the three-dimensional model thus generated and the plurality of three-dimensional models 3DM stored in the storage section 16. Then, the searching section 122 identifies, as a three-dimensional model corresponding to the object included in the three-dimensionally scanned data, a three-dimensional model candidate having a highest similarity output from the similarity determination model.

A specific configuration of the similarity determination model is also not limited, and may be, for example, CNN, RNN, or a combination thereof. For another example, a non-neural network model such as Random Forest and Support Vector Machine may be employed.

As discussed above, the searching section 122 performs searching with use of similarities between a three-dimensional model and three-dimensional model candidates. This makes it possible to identify an appropriate three-dimensional model.

(One Example of Process to be Executed by Presenting Section 123 and Selecting Section 124)

The following will describe an example of a process to be executed by the presenting section 123 and a process to be executed by the selecting section 124.

In an example, the presenting section 123 refers to the similarities used by the searching section 122, and obtains, from among the plurality of three-dimensional models 3DM stored in the storage section 16, a plurality of three-dimensional model candidates having a relatively high similarity. The presenting section 123 outputs, to the terminal device 2 via the communication section 15, the plurality of three-dimensional model candidates thus obtained, thereby presenting the plurality of three-dimensional model candidates to the user.

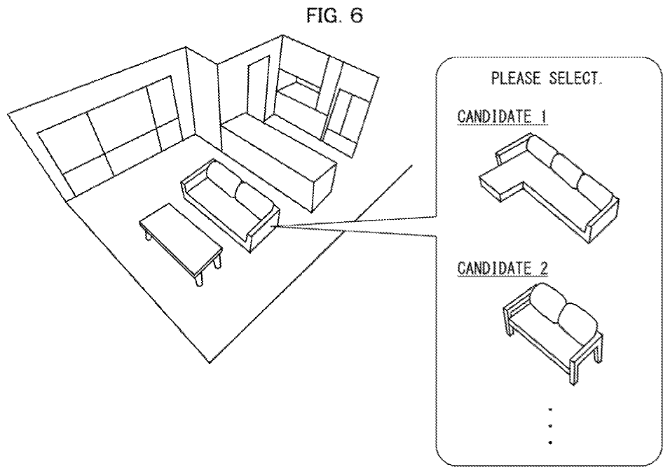

The control section 20 of the terminal device 2 obtains, via the communication section 25, the plurality of three-dimensional model candidates output from the information processing device 1A. The control section 20 presents, to the user via the input-output section 26, an image including the plurality of three-dimensional model candidates thus obtained. An example of the image presented to the user will be described with reference to FIG. 6. FIG. 6 is a view illustrating an example of an image to be presented to the user in the present example embodiment.

As shown in FIG. 6, the control section 20 presents, to the user, an image including a plurality of three-dimensional model candidates (“candidate 1” and “candidate 2”). Further, the control section 20 may indicate to which one of the objects included in the three-dimensionally scanned data the plurality of three-dimensional model candidates correspond. In the image shown in FIG. 6, the control section 20 indicates (a) a plurality of three-dimensional model candidates for a “sofa” and (b) a “sofa” corresponding to the three-dimensional model candidates and being included in the three-dimensionally scanned data.

Subsequently, the control section 20 obtains, via the input-output section 26, information indicating which one of the plurality of three-dimensional model candidates the user has selected. The control section 20 outputs the obtained information to the information processing device 1A via the communication section 25.

The selecting section 124 of the information processing device 1A obtains, via the communication section 15, the information indicating which one of the plurality of three-dimensional model candidates the user has selected. The selecting section 124 refers to the obtained information, and selects a three-dimensional model corresponding to at least any one of the one or more subjects on the basis of the input from the user.

In an example, in a case where the user selects “candidate 1” in the image shown in FIG. 6, the selecting section 124 obtains, from among the three-dimensional models 3DM stored in the storage section 16, a three-dimensional model corresponding to “candidate 1”. Then, the selecting section 124 supplies the obtained three-dimensional model to the output section 13 and the generating section 17.

As discussed above, the presenting section 123 presents, to a user, a plurality of three-dimensional model candidates having a relatively high similarity, and the selecting section 124 selects a three-dimensional model on the basis of an input from the user. This makes it possible to identify a more appropriate three-dimensional model.

(Example 1 of Process to be Executed by Generating Section 17)

The following will describe an example of a process to be executed by the generating section 17.

The generating section 17 generates a stereoscopically visible image which can be obtained by referring to three-dimensionally scanned data obtained by the obtaining section 11 and in which at least any one of the one or more subjects is replaced with a three-dimensional model. Then, the generating section 17 supplies to the generated image to the output section 13.

As discussed above, the generating section 17 generates a stereoscopically visible image in which a subject is replaced with a three-dimensional model. This makes it possible to provide a stereoscopically visible image including a three-dimensional model of a subject included in three-dimensionally scanned data.

Further, the process in which the generating section 17 replaces the subject with the three-dimensional model may include (a) a process of referring to the three-dimensionally scanned data and changing at least either of the size and the shape of the three-dimensional model and (b) a process of replacing at least any one of the one or more subjects with the three-dimensional model at least either of the size and shape of which has been changed.

In an example, the generating section 17 may change at least either of the size and the shape of the three-dimensional model according to the size and the shape of the subject which is included in the three-dimensionally scanned data and which corresponds to the three-dimensional model. For example, in replacing the subject “sofa” included in the three-dimensionally scanned data with the three-dimensional model as shown in FIG. 5, the generating section 17 may change at least either of the size and the shape of the three-dimensional model according to at least either of the size and the shape of the subject “sofa” included in the three-dimensionally scanned data.

As discussed above, the generating section 17 refers to three-dimensionally scanned data and changes at least either of the size and the shape of a three-dimensional model, and then the generating section 17 replaces at least any one of one or more subjects with the three-dimensional model at least either of the size and the shape of which has been changed. Therefore, the generating section 17 can generate an image including the three-dimensional model adapted to the subject included in the three-dimensionally scanned data.

(Example 2 of Process to be Executed by Generating Section 17)

The following will describe another example of a process to be executed by the generating section 17.

The process in which the generating section 17 replaces the subject with the three-dimensional model may include (a) a process of generating a texture image on the basis of an image included in the three-dimensionally scanned data or an image obtained independently of the three-dimensionally scanned data and (b) a process of pasting the generated texture image to a surface of the three-dimensional model.

In an example, the generating section 17 generates a texture image on the basis of (a) an image of a surface of the subject which is included in the three-dimensionally scanned data and which corresponds to the three-dimensional model or (b) an image stored in the storage section 16. The generating section 17 may paste the generated texture image to the surface of the three-dimensional model.

In pasting the texture image to the surface of the three-dimensional model, the generating section 17 preferably deforms the texture image according to the shape of the three-dimensional model. In an example, the generating section 17 uses the deformed three-dimensional model as the image obtained independently of the three-dimensionally scanned data, and generates a texture image on the basis of that image. With this configuration, the generating section 17 can generate an image including a suitable three-dimensional model.

Further, in a case where the generating section 17 generates a texture image on the basis of an image stored in the storage section 16, the generating section 17 may obtain, from the storage section 16, an image similar to an image of a surface of a subject which is included in the three-dimensionally scanned data and which corresponds to the three-dimensional model. In this configuration, the generating section 17 may use a similarity determination model that accepts two images as an input and determines a similarity between the two images.

In another example, the generating section 17 may be configured to obtain a plurality of image candidates from the storage section 16 and supply the images to the presenting section 123, and the presenting section 123 may be configured to present, to the user, the plurality of image candidates. In the configuration, the selecting section 124 may select, on the basis of user's input, an image from among the plurality of image candidates, and may supply the image to the generating section 17.

As discussed above, the generating section 17 generates a texture image on the basis of an image included in three-dimensionally scanned data or an image obtained independently of the three-dimensionally scanned data, and pastes the generated texture image to a surface of a three-dimensional model. Therefore, the generating section 17 can generate an image including a three-dimensional model adapted to a subject included in the three-dimensionally scanned data.

(Example 3 of Process to be Executed by Generating Section 17)

The following will describe another example of a process to be executed by the generating section 17.

The generating section 17 may generate an image in which, among the one or more subjects, an object(s) existing at a position(s) separated relatively far away from a reference point is included as a stereoscopically invisible object.

In an example, when one or more subjects are sensed, the generating section 17 may (a) use, as a reference point, a position where the image-capturing device that has captured an image of one or more subjects resides and (b) generate an image including, as a stereoscopically invisible object, an object existing at a position farmost from the image-capturing device. For another example, the generating section 17 may generate an image including, as a stereoscopically invisible object, an object whose distance from the image-capturing device could not be measured.

The “stereoscopically invisible image” may be, for example, an image generated on the basis of two-dimensional data. Alternatively, the “non-stereoscopically visible image” may be an image that is a combination of template-like two-dimensional images which are prepared in advance.

As discussed above, the generating section 17 generates an image in which, among the one or more subjects, an object(s) existing at a position(s) separated relatively far away from a reference point is included as a stereoscopically invisible object. Therefore, the generating section 17 can reduce a burden of the replacing process.

(Effects of Information Processing System 100A)

As discussed above, in the information processing system 100A in accordance with the present example embodiment, the information processing device 1A refers to three-dimensionally scanned data obtained by the terminal device 2, and identifies a three-dimensional model corresponding to at least any one of one or more subjects included in the three-dimensionally scanned data. Then, the information processing device 1A outputs, to the terminal device 2, the three-dimensional model thus identified. The terminal device 2 obtains the three-dimensional model thus output.

Thus, with the information processing system 100A in accordance with the present example embodiment, it is possible to attain the effect of suitably providing a three-dimensional model of a subject.

### Third Example Embodiment

The following description will discuss a third example embodiment of the present invention in detail with reference to the drawings. Note that members having identical functions to those of the foregoing example embodiments are given identical reference signs, and a description thereof will be omitted.

(Configuration of Information Processing System 100B)

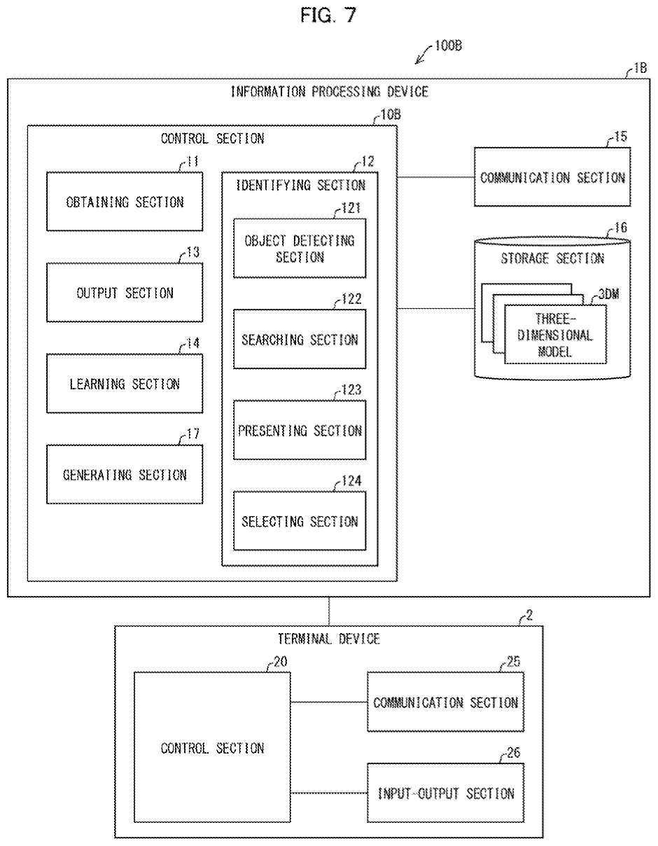

The following will describe, with reference to FIG. 7, an information processing system 100B in accordance with the present example embodiment. FIG. 7 is a block diagram illustrating a configuration of the information processing system 100B in accordance with the present example embodiment.

As shown in FIG. 7, the information processing system 100B in accordance with the present example embodiment includes an information processing device 1B and a terminal device 2. Similarly to the foregoing example embodiments, the information processing device 1B and the terminal device 2 are communicably connected to each other.

In the information processing system 100B, the information processing device 1B presents, to a user, one or more other three-dimensional model candidates, and outputs a three-dimensional model candidate to the terminal device 2 on the basis of an input from the user. Further, in the information processing system 100B, the information processing device 1B causes the similarity determination model, used by the above-described searching section 122, to perform learning.

The terminal device 2 of the information processing system 100B is identical in configuration to the above-discussed terminal device 2. Therefore, a description thereof will be omitted.

(Configuration of Information Processing Device 1B)

As shown in FIG. 7, the information processing device 1B includes a control section 10B, a communication section 15, and a storage section 16. The communication section 15 and the storage section 16 are as discussed earlier.

The control section 10B controls constituent elements included in the information processing device 1B. As shown in FIG. 7, the control section 10B functions also as an obtaining section 11, an identifying section 12, an output section 13, a generating section 17, and a learning section 14. The obtaining section 11, the identifying section 12, the output section 13, the generating section 17, and the learning section 14 respectively realize an obtaining means, an identifying means, an output means, a generating means, and a learning means in the present example embodiment.

The obtaining section 11, the identifying section 12, and the generating section 17 are as discussed earlier. That is, as shown in FIG. 7, the identifying section 12 may function as an object detecting section 121, a searching section 122, a presenting section 123, and a selecting section 124. The object detecting section 121, the searching section 122, the presenting section 123, and the selecting section 124 respectively realize an object detecting means, a searching means, a presenting means, and a selecting means in the present example embodiment.

The output section 13 outputs a three-dimensional model having been identified.

The output section 13 accepts user's selection of the three-dimensional model thus output, and outputs one or more other three-dimensional model candidates corresponding to the selected three-dimensional model. Then, the output section 13 accepts user's selection of any of the other three-dimensional model candidates, and outputs the three-dimensional model candidate thus selected. An example of the process to be performed by the output section 13 will be described later.

The learning section 14 causes the similarity determination model, used by the searching section 122, to perform learning with use of information indicating which of the other three-dimensional model candidates has been selected by the user. An example of the process to be executed by the learning section 14 will be described later.

(One Example of Process to be Executed by Output Section 13)

The following will describe an example of a process to be executed by the output section 13.

In an example, the output section 13 outputs the image which includes the three-dimensional model identified by the identifying section 12 and which is generated by the generating section 17. In this case, the generating section 17 generates a stereoscopically visible image (hereinafter, referred to as a “first image”) which can be obtained by referring to the three-dimensionally scanned data and in which at least any one of the one or more subjects is replaced with a three-dimensional model. Then, the output section 13 outputs, to the terminal device 2, (a) the first image generated by the generating section 17 and (b) the one or more other three-dimensional model candidates corresponding to the three-dimensional model identified by the identifying section 12.

For example, in a case where the generating section 17 generates a first image in which a subject “sofa” is replaced with a three-dimensional model, the output section 13 obtains, from among three-dimensional models 3DM stored in the storage section 16, the one or more other three-dimensional model candidates corresponding to the three-dimensional model with which the “sofa” is replaced.

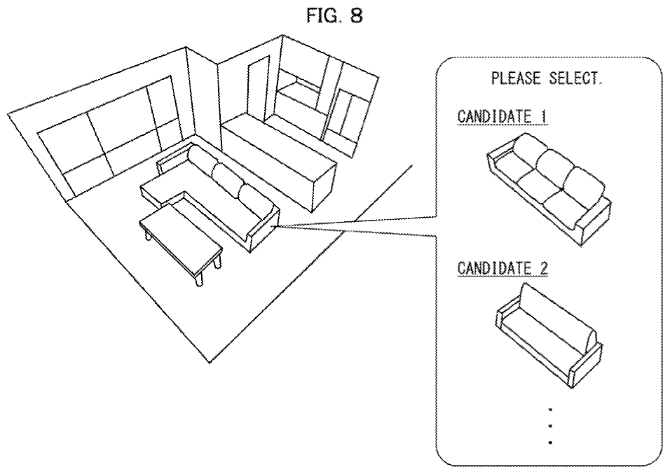

The control section 20 of the terminal device 2 obtains, via the communication section 25, the first image output from the information processing device 1B and the one or more other three-dimensional model candidates. Then, the control section 20 presents, to the user via the input-output section 26, the first image and the one or more other three-dimensional model candidates thus obtained. An example of the image that the control section 20 presents to the user will be described with reference to FIG. 8. FIG. 8 is a view illustrating an example of the image to be presented to the user in the present example embodiment.

As shown in FIG. 8, the control section 20 presents, to the user, (a) the first image which is the stereoscopically visible image which is generated by the generating section 17 and in which the subject “sofa” is replaced with the three-dimensional model and (b) the image including the other three-dimensional model candidates (“candidate 1” and “candidate 2”) corresponding to the three-dimensional model of the subject “sofa”.

Subsequently, the control section 20 obtains, via the input-output section 26, information indicating which one of the other three-dimensional model candidates the user has selected. The control section 20 outputs the obtained information to the information processing device 1B via the communication section 25.

The output section 13 of the information processing device 1B obtains, via the communication section 15, the information indicating which one of the other three-dimensional model candidates the user has selected. The output section 13 refers to the obtained information, and outputs the other three-dimensional model candidate selected by the user.

In an example, the output section 13 outputs, to the terminal device 2, an image (hereinafter, referred to as a “second image”) which is generated by the generating section 17 and in which the three-dimensional model shown in the first image is replaced with the other three-dimensional model candidate selected by the user.

For example, in a case where the user selects “candidate 1” in the image shown in FIG. 8, the output section 13 obtains, from among the three-dimensional models 3DM stored in the storage section 16, a three-dimensional model corresponding to “candidate 1”. Then, the generating section 17 generates the second image in which the three-dimensional model shown in the first image is replaced with the obtained three-dimensional model.

(One Example of Process to be Executed by Learning Section 14)

The following will describe an example of a process to be executed by the learning section 14.

In an example, the learning section 14 refers to the information that is obtained by the output section 13 and that indicates which of the other three-dimensional model candidates the user has selected, and causes the similarity determination model, used by the searching section 122, to perform learning.

For example, the learning section 14 refers to the information that is obtained by the output section 13 and that indicates which of the other three-dimensional model candidates the user has selected, and obtains the other three-dimensional model candidate selected by the user. Further, the learning section 14 obtains the three-dimensional model of the object included in the three-dimensionally scanned data detected by the object detecting section 121, and creates training data including a pair of the three-dimensional model and the obtained other three-dimensional model candidate. Then, the learning section 14 causes the similarity determination model to perform learning with use of the training data. In other words, the learning section 14 causes the similarity determination model to perform learning so that the similarity determination model outputs a high similarity upon reception of input of (a) the three-dimensional model of the object included in the three-dimensionally scanned data detected by the object detecting section 121 and (b) the other three-dimensional model candidate selected by the user.

(Effects of Information Processing System 100B)

As discussed above, in the information processing system 100B in accordance with the present example embodiment, the information processing device 1B accepts user's selection of a three-dimensional model made in the generated image, and presents the one or more other three-dimensional model candidates corresponding to the selected three-dimensional model. Then, the information processing device 1B accepts user's selection of any one of the other three-dimensional model candidates, and outputs the selected three-dimensional model candidate.

Therefore, the information processing system 100B in accordance with the present example embodiment makes it possible not only to provide the effects given by the information processing device 1 in accordance with the first example embodiment but also to output a three-dimensional model adapted to a subject included in three-dimensionally scanned data.

Further, in the information processing system 100B in accordance with the present example embodiment, the information processing device 1B causes the similarity determination model, used by the searching section 122, to perform learning with use of information, received from the user, indicating which of the other three-dimensional model candidates the user has selected.

Therefore, the information processing system 100B in accordance with the present example embodiment makes it possible not only to provide the effects given by the information processing device 1 in accordance with the first example embodiment but also to enhance the accuracy of determination of the similarity determination model.

### Fourth Example Embodiment

The following description will discuss a fourth example embodiment of the present invention in detail with reference to the drawings. Note that members having identical functions to those of the foregoing example embodiments are given identical reference signs, and a description thereof will be omitted.

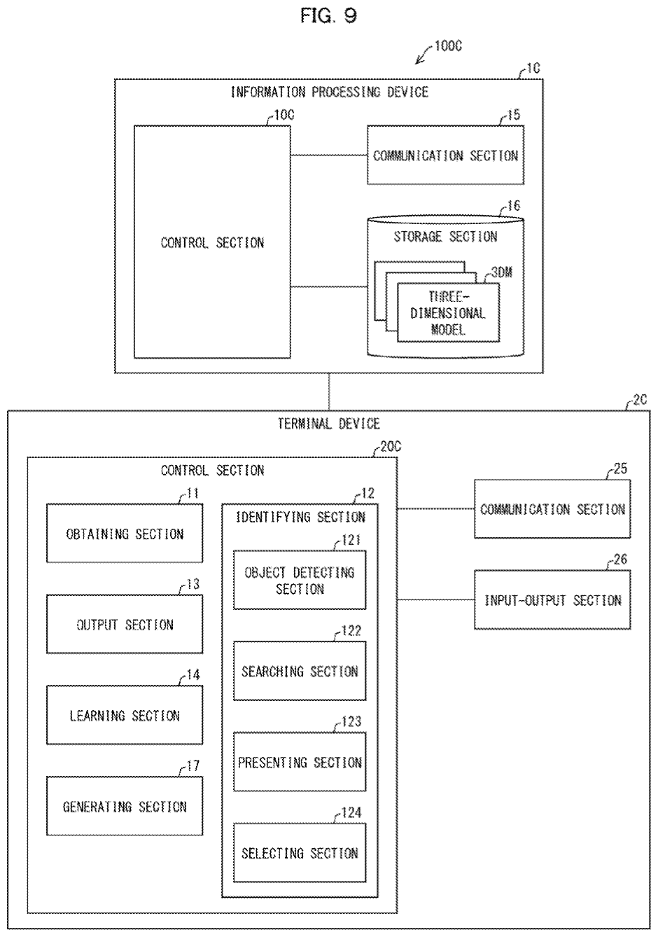

(Configuration of Information Processing System 100C) The following will describe, with reference to FIG. 9, an information processing system 100C in accordance with the present example embodiment. FIG. 9 is a block diagram illustrating a configuration of the information processing system 100C in accordance with the present example embodiment.

As shown in FIG. 9, the information processing system 100C in accordance with the present example embodiment includes an information processing device 1C and a terminal device 2C. Similarly to the foregoing example embodiments, the information processing device 1C and the terminal device 2C are communicably connected to each other.

In the information processing system 100C, the terminal device 2C refers to three-dimensionally scanned data having been obtained, and identifies a three-dimensional model corresponding to at least any one of one or more subjects included in the three-dimensionally scanned data. Then, the terminal device 2C obtains, from the information processing device 1C, the three-dimensional model thus identified, and then presents the three-dimensional model thus obtained. In an example, the terminal device 2C presents, to a user, a stereoscopically visible image in which at least any one of the one or more subjects is replaced with the three-dimensional model. That is, the terminal device 2C has the function of the above-described information processing device 1.

The one or more subjects, the three-dimensionally scanned data, and the stereoscopically visible image are as discussed earlier.

(Configuration of Terminal Device 2C)

As shown in FIG. 9, the terminal device 2C includes a control section 20C, a communication section 25, and an input-output section 26. The communication section 25 and the input-output section 26 are as discussed earlier.

The control section 20C controls constituent elements included in the terminal device 2C. As shown in FIG. 9, the control section 20C functions also as an obtaining section 11, an identifying section 12, an output section 13, a generating section 17, and a learning section 14. The obtaining section 11, the identifying section 12, the output section 13, the generating section 17, and the learning section 14 respectively realize an obtaining means, an identifying means, an output means, a generating means, and a learning means in the present example embodiment.

The obtaining section 11 obtains data supplied from the communication section 25 or the input-output section 26. Examples of the data to be obtained by the obtaining section 11 include three-dimensionally scanned data, information indicating an input from a user, and a three-dimensional model. The obtaining section 11 supplies the data thus obtained to the identifying section 12 or the communication section 25.

The identifying section 12 refers to the three-dimensionally scanned data, and identifies a three-dimensional model corresponding to at least any one of the one or more subjects.

As shown in FIG. 9, the identifying section 12 may include an object detecting section 121, a searching section 122, a presenting section 123, and a selecting section 124. The object detecting section 121, the searching section 122, the presenting section 123, and the selecting section 124 respectively realize an object detecting means, a searching means, a presenting means, and a selecting means in the present example embodiment.

The object detecting section 121, the presenting section 123, and the selecting section 124 are as discussed earlier.

The searching section 122 searches, in a plurality of three-dimensional model candidates, for a three-dimensional model corresponding to at least any one of the one or more objects. For example, the searching section 122 requests the information processing device 1C to output the three-dimensional model corresponding to at least any one of the one or more objects identified by the object detecting section 121. Then, the searching section 122 obtains, via the communication section 25, the three-dimensional model that the information processing device 1C has output in response to the request. The searching section 122 supplies the obtained three-dimensional model to the output section 13 and the generating section 17.

The searching section 122 may perform the searching with use of similarities between the three-dimensional model and the three-dimensional model candidates. The process in which the searching section 122 performs the searching with use of similarities is as discussed earlier.

The generating section 17 generates a stereoscopically visible image which can be obtained by referring to the three-dimensionally scanned data and in which at least any one of the one or more subjects is replaced with a three-dimensional model. The generating section 17 supplies the generated image to the output section 13.

The output section 13 and the learning section 14 are as discussed earlier.

(Configuration of Information Processing Device 1C)

As shown in FIG. 9, the information processing device 1C includes a control section 10C, a communication section 15, and a storage section 16. The communication section 15 and the storage section 16 are as discussed earlier.

The control section 10C controls constituent elements included in the information processing device 1C. In an example, the control section 10C accepts, via the communication section 15, a request to output a three-dimensional model which request is supplied from the terminal device 2C. Next, the control section 10C obtains, from among three-dimensional models 3DM stored in the storage section 16, a three-dimensional model corresponding to the request. Then, the control section 10C outputs the obtained three-dimensional model to the terminal device 2C via the communication section 15.

(Effects of Information Processing System 100C)

As discussed above, in the information processing system 100C in accordance with the present example embodiment, the terminal device 2C refers to three-dimensionally scanned data having been obtained, and identifies a three-dimensional model corresponding to at least any one of one or more subjects included in the three-dimensionally scanned data. Then, the terminal device 2C obtains, from the information processing device 1C, the three-dimensional model thus identified, and then outputs the three-dimensional model. Thus, with the information processing system 100C in accordance with the present example embodiment, it is possible to attain similar effects to those given by the above-described information processing device 1.

### Software Implementation Example

Some or all of functions of the information processing devices 1, 1A, 1B, and 1C and the terminal devices 2 and 2C can be realized by hardware such as an integrated circuit (IC chip) or can be alternatively realized by software.

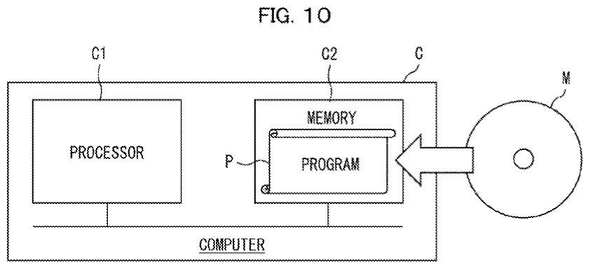

In the latter case, each of the information processing devices 1, 1A, 1B, and 1C and the terminal devices 2 and 2C is realized by, for example, a computer that executes instructions of a program that is software realizing the foregoing functions. FIG. 10 shows an example of such a computer (hereinafter, referred to as a “computer C”). The computer C includes at least one processor C1 and at least one memory C2. The memory C2 has a program P stored therein, the program P causing the computer C to operate as the information processing devices 1, 1A, 1B, and 1C and the terminal devices 2 and 2C. In the computer C, the processor C1 reads and executes the program P from the memory C2, thereby realizing the functions of the information processing devices 1, 1A, 1B, and 1C and the terminal devices 2 and 2C.

The processor C1 may be, for example, Central Processing Unit (CPU), Graphic Processing Unit (GPU), Digital Signal Processor (DSP), Micro Processing Unit (MPU), Floating point number Processing Unit (FPU), Physics Processing Unit (PPU), a microcontroller, or a combination of any of them. The memory C2 may be, for example, a flash memory, Hard Disk Drive (HDD), Solid State Drive (SSD), or a combination of any of them.

The computer C may further include a random access memory (RAM) in which the program P is loaded when executed and various data is temporarily stored. In addition, the computer C may further include a communication interface via which the computer C transmits/receives data to/from another device. The computer C may further include an input-output interface via which the computer C is connected to an input-output device such as a keyboard, a mouse, a display, and/or a printer.

The program P can be stored in a non-transitory, tangible storage medium M capable of being read by the computer C. Examples of such a storage medium M encompass a tape, a disk, a card, a memory, a semiconductor memory, and a programmable logic circuit. The computer C can obtain the program P via the storage medium M. Alternatively, the program P can be transmitted via a transmission medium. Examples of such a transmission medium encompass a communication network and a broadcast wave. The computer C can also obtain the program P via the transmission medium.

[Supplementary Note 1]

The present invention is not limited to the example embodiments, but can be altered by a skilled person in the art within the scope of the claims. The present invention also encompasses, in its technical scope, any embodiment derived by combining technical means disclosed in differing embodiments.

[Supplementary Note 2]

Some or all of the above embodiments can be described as below. Note however that the present invention is not limited to aspects described below.

(Supplementary Remarks 1)

An information processing device including: an obtaining means that obtains three-dimensionally scanned data obtained by sensing one or more objects; an identifying means that refers to the three-dimensionally scanned data and identifies a three-dimensional model corresponding to at least any one of the one or more objects; and an output means that outputs the three-dimensional model thus identified, the identifying means including: an object detecting means that performs a process of object detection on the three-dimensionally scanned data, so as to identify the at least any one of the one or more objects, and the searching means that searches, in a plurality of three-dimensional model candidates, for the three-dimensional model corresponding to the at least any one of the one or more objects.

(Supplementary Remarks 2)

The information processing device described in Supplementary Remarks 1, wherein: the searching means performs the searching with use of similarities between the three-dimensional model and the plurality of three-dimensional model candidates; and the identifying means includes a presenting means that presents, to a user, a plurality of three-dimensional model candidates having a relatively high similarity and a selecting means that selects, on a basis of an input from the user, the three-dimensional model corresponding to the at least any one of the one or more objects.

(Supplementary Remarks 3)

The information processing device described in Supplementary Remarks 1 or 2, wherein: the object detecting means accepts information designating a partial space in a subject space including the one or more objects, and applies the process of object detection to three-dimensionally scanned data corresponding to the partial space identified on a basis of the information designating the partial space.

(Supplementary Remarks 4)

The information processing device described in any one of Supplementary Remarks 1 to 3, wherein: the output means accepts user's selection of the three-dimensional model output in the output process, outputs one or more other three-dimensional model candidates corresponding to the three-dimensional model thus selected, accepts user's selection of any one of the one or more other three-dimensional model candidates, and outputs, as the three-dimensional model, the selected one of the one or more other three-dimensional model candidates.

(Supplementary Remarks 5)

The information processing device described in Supplementary Remarks 4, further including: a learning means that causes a similarity determination model used by the searching means to perform learning with use of the information supplied from the user, the information indicating which of the one or more other three-dimensional model candidates has been selected.

(Supplementary Remarks 6)

The information processing device described in any one of Supplementary Remarks 1 to 5, further including a generating means that generates an image which is stereoscopically visible, which is obtained by referring to the three-dimensionally scanned data, and in which the at least any one of the one or more objects is replaced with the three-dimensional model.

(Supplementary Remarks 7)

The information processing device described in Supplementary Remarks 6, wherein: a process, performed by the generating means, of replacing the at least any one of the one or more objects with the three-dimensional model includes a process of referring to the three-dimensionally scanned data and changing at least either of a size and a shape of the three-dimensional model, and a process of replacing the at least any one of the one or more objects with the three-dimensional model at least either of the size and the shape of which has been changed.

(Supplementary Remarks 8)

The information processing device described in Supplementary Remarks 6 or 7, wherein: a process, performed by the generating means, of replacing the at least any one of the one or more objects with the three-dimensional model includes a process of generating a texture image on a basis of an image included in the three-dimensionally scanned data or an image obtained independently of the three-dimensionally scanned data, and a process of pasting, to a surface of the three-dimensional model, the texture image thus generated.

(Supplementary Remarks 9)

The information processing device described in any one of Supplementary Remarks 6 to 8, wherein: the generating means generates, as the image, an image in which, among the one or more objects, an object existing at a position separated relatively far away from a reference point is included as a stereoscopically invisible object.

(Supplementary Remarks 10)

The information processing device described in any one of Supplementary Remarks 1 to 9, wherein: the output means further outputs three-dimensional data corresponding to at least part of the three-dimensionally scanned data.

(Supplementary Remarks 11)

An information processing method including: an information processing device three-dimensionally scanned data obtained by sensing one or more objects; the information processing device referring to the three-dimensionally scanned data and identifying a three-dimensional model corresponding to at least any one of the one or more objects; and the information processing device outputting the three-dimensional model thus identified, the identifying including: performing a process of object detection on the three-dimensionally scanned data, so as to identify the at least any one of the one or more objects, and searching, in a plurality of three-dimensional model candidates, for the three-dimensional model corresponding to the at least any one of the one or more objects.

(Supplementary Remarks 12)

A computer-readable non-transitory storage medium in which a program is stored, the program causing a computer to function as an information processing device, the program causing the computer to function as: an obtaining means that obtains three-dimensionally scanned data obtained by sensing one or more objects; an identifying means that refers to the three-dimensionally scanned data and identifies a three-dimensional model corresponding to at least any one of the one or more objects; an output means that outputs the three-dimensional model thus identified, the identifying means functioning as: an object detecting means that performs a process of object detection on the three-dimensionally scanned data, so as to identify the at least any one of the one or more objects; and a searching means that searches, in a plurality of three-dimensional model candidates, for the three-dimensional model corresponding to the at least any one of the one or more objects.

(Supplementary Remarks 13)

An information processing device including at least one processor configured to execute: an obtaining process of obtaining three-dimensionally scanned data obtained by sensing one or more objects; an identifying process of referring to the three-dimensionally scanned data and identifying a three-dimensional model corresponding to at least any one of the one or more objects; and an output process of outputting the three-dimensional model thus identified, the at least one processor being further configured to execute, in the identifying process, an object detecting process and a searching process, the object detecting process performing a process of object detection on the three-dimensionally scanned data, so as to identify the at least any one of the one or more objects, and the searching process searching, in a plurality of three-dimensional model candidates, for the three-dimensional model corresponding to the at least any one of the one or more objects.

Note that the information processing device may further include a memory. In the memory, a program for causing the processor to execute the obtaining process, the identifying process, the output process, the object detecting process, and the searching process may be stored. This program may be stored in a computer-readable non-transitory tangible storage medium.

### REFERENCE SIGNS LIST

1, 1A, 1B, 1C: information processing device
11: obtaining section
12: identifying section
13: output section
14: learning section
17: generating section
121: object detecting section
122: searching section
123: presenting section
124: selecting section
2, 2C: terminal device
100A, 100B, 100C: information processing system

1. An information processing device comprising at least one processor configured to execute:
an obtaining process of obtaining three-dimensionally scanned data obtained by sensing one or more objects;
an identifying process of referring to the three-dimensionally scanned data and identifying a three-dimensional model corresponding to at least any one of the one or more objects; and
an output process of outputting the three-dimensional model thus identified,
the at least one processor being further configured to execute, in the identifying process, an object detecting process and a searching process,
the object detecting process performing a process of object detection on the three-dimensionally scanned data, so as to identify the at least any one of the one or more objects, and
the searching process searching, in a plurality of three-dimensional model candidates, for the three-dimensional model corresponding to the at least any one of the one or more objects.

2. The information processing device according to claim 1, wherein:
in the searching process, the at least one processor performs the searching with use of similarities between the three-dimensional model and the plurality of three-dimensional model candidates; and
in the identifying process, the at least one processor performs a presenting process and a selecting process,
the presenting process presenting, to a user, a plurality of three-dimensional model candidates having a relatively high similarity and
the selecting process selecting, on a basis of an input from the user, the three-dimensional model corresponding to the at least any one of the one or more objects.

3. The information processing device according to claim 1, wherein:
in the object detecting process,
the at least one processor accepts information designating a partial space in a subject space including the one or more objects, and
the at least one processor applies the process of object detection to three-dimensionally scanned data corresponding to the partial space identified on a basis of the information designating the partial space.

4. The information processing device according to claim 1, wherein:
in the output process,
the at least one processor accepts user's selection of the three-dimensional model output in the output process,
the at least one processor outputs one or more other three-dimensional model candidates corresponding to the three-dimensional model thus selected,
the at least one processor accepts user's selection of any one of the one or more other three-dimensional model candidates, and
the at least one processor outputs, as the three-dimensional model, the selected one of the one or more other three-dimensional model candidates.

5. The information processing device according to claim 4, wherein:
the at least one processor executes a learning process of causing a similarity determination model used in the searching process to perform learning with use of the information supplied from the user, the information indicating which of the one or more other three-dimensional model candidates has been selected.

6. The information processing device according to claim 1, wherein:
the at least one processor is further configured to execute a generating process of generating an image which is stereoscopically visible, which is obtained by referring to the three-dimensionally scanned data, and in which the at least any one of the one or more objects is replaced with the three-dimensional model.

7. The information processing device according to claim 6, wherein:
a process, included in the generating process, of replacing the at least any one of the one or more objects with the three-dimensional model includes
a process of referring to the three-dimensionally scanned data and changing at least either of a size and a shape of the three-dimensional model, and
a process of replacing the at least any one of the one or more objects with the three-dimensional model at least either of the size and the shape of which has been changed.

8. The information processing device according to claim 6, wherein:
a process, included in the generating process, of replacing the at least any one of the one or more objects with the three-dimensional model includes
a process of generating a texture image on a basis of an image included in the three-dimensionally scanned data or an image obtained independently of the three-dimensionally scanned data, and
a process of pasting, to a surface of the three-dimensional model, the texture image thus generated.

9. The information processing device according to claim 6, wherein:
in the generating process, the at least one processor generates, as the image, an image in which, among the one or more objects, an object existing at a position separated relatively far away from a reference point is included as a stereoscopically invisible object.

10. The information processing device according to claim 1, wherein:
in the output process, the at least one processor further outputs three-dimensional data corresponding to at least part of the three-dimensionally scanned data.

11. An information processing method comprising:
at least one processor obtaining three-dimensionally scanned data obtained by sensing one or more objects;
the at least one processor referring to the three-dimensionally scanned data and identifying a three-dimensional model corresponding to at least any one of the one or more objects; and
the at least one processor outputting the three-dimensional model thus identified,
the identifying including:
performing a process of object detection on the three-dimensionally scanned data, so as to identify the at least any one of the one or more objects, and
searching, in a plurality of three-dimensional model candidates, for the three-dimensional model corresponding to the at least any one of the one or more objects.

12. A computer-readable non-transitory storage medium in which a program is stored, the program causing a computer to function as an information processing device,
the program causing the computer to execute:
an obtaining process of obtaining three-dimensionally scanned data obtained by sensing one or more objects;
an identifying process of referring to the three-dimensionally scanned data and identifying a three-dimensional model corresponding to at least any one of the one or more objects;
an output process of outputting the three-dimensional model thus identified,
the program causing the computer to further execute, in the identifying process, an object detecting process and a searching process:
the object detecting process performing a process of object detection on the three-dimensionally scanned data, so as to identify the at least any one of the one or more objects; and
the searching process searching, in a plurality of three-dimensional model candidates, for the three-dimensional model corresponding to the at least any one of the one or more objects.
